(19) United States
(12) Patent Application Publication
(10) Pub. No.: US 2024/0273742 A1
(43) Pub. Date: Aug. 15, 2024

(54) DEPTH COMPLETION USING IMAGE AND SPARSE DEPTH INPUTS

(71) Applicant: QUALCOMM Incorporated, San Diego, CA (US)

(72) Inventors: Debasmit DAS, San Diego, CA (US); Varun RAVI KUMAR, San Diego, CA (US); Shubhankar Mangesh BORSE, San Diego, CA (US); Senthil Kumar YOGAMANI, Headford (IE)

(21) Appl. No.: 18/165,163

(22) Filed: Feb. 6, 2023

(51) Int. Cl. G06T 7/50; G06T 7/10; G06V 10/26; G06V 10/70; G06V 10/764; G06V 10/82

(52) U.S. Cl. CPC G06T 7/50; G06T 7/10; G06V 10/26; G06V 10/764; G06V 10/768; G06V 10/82; G06T 2207/20021; G06T 2207/20072; G06T 2207/20081; G06T 2207/20084

(57) ABSTRACT

Disclosed are systems, apparatuses, processes, and computer-readable media for processing image data. For example, a process can include obtaining segmentation information associated with an image of a scene, the image including a plurality of pixels having a resolution, and obtaining depth information associated with one or more objects in the scene. A plurality of features can be generated corresponding to the plurality of pixels, wherein each feature of the plurality of features corresponds to a particular pixel of the plurality of pixels, and wherein each feature includes respective segmentation information of the particular pixel and respective depth information of the particular pixel. The plurality of features can be processed to generate a dense depth output corresponding to the image.

### FIELD

The present disclosure generally relates to depth estimation from one or more images. For example, aspects of the present disclosure relate to systems and techniques for performing depth completion using a graph neural network based on image and sparse depth inputs.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for performing depth estimation using a machine learning system (e.g., a neural network system or model) based on image data and sparse depth data. In some cases, a graph-based neural network can determine depth completion information based on a segmentation input and a sparse depth input. According to at least one illustrative example, a method for generating depth information from one or more images is provided, the method comprising: obtaining segmentation information associated with an image of a scene, the image including a plurality of pixels having a resolution; obtaining depth information associated with one or more objects in the scene; generating a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and processing the plurality of features to generate a dense depth output corresponding to the image.

In another example, an apparatus for generating depth information from one or more images is provided. The apparatus includes at least one memory configured and at least one processor coupled to the at least one memory and configured to: obtain segmentation information associated with an image of a scene, the image including a plurality of pixels having a resolution; obtain depth information associated with one or more objects in the scene; generate a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and process the plurality of features to generate a dense depth output corresponding to the image.

In another example, a system for generating depth information from one or more images is provided, the system comprising at least one memory and at least one processor coupled to the at least one memory, the at least one processor configured to: obtain segmentation information associated with an image of a scene, the image including a plurality of pixels having a resolution; obtain depth information associated with one or more objects in the scene; generate a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and process the plurality of features to generate a dense depth output corresponding to the image.

In another example, a non-transitory computer-readable medium is provided that includes instructions that, when executed by at least one processor, cause the at least one processor to: obtain segmentation information associated with an image of a scene, the image including a plurality of pixels having a resolution; obtain depth information associated with one or more objects in the scene; generate a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and process the plurality of features to generate a dense depth output corresponding to the image.

In another example, an apparatus is provided that includes: means for obtaining segmentation information associated with an image of a scene, the image including a plurality of pixels having a resolution; means for obtaining depth information associated with one or more objects in the scene; means for generating a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and means for processing the plurality of features to generate a dense depth output corresponding to the image.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

The same reference numbers in different drawings may identify the same or similar elements.

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 2C illustrates an example of a convolutional neural network, in accordance with some examples;

FIG. 3 illustrates an example of a machine learning architecture for generating a dense depth map using depth completion, in accordance with some examples;

FIG. 4 illustrates an example of a graph neural network that can be used as a refinement network for generating a dense depth map using depth completion, in accordance with some examples;

FIG. 5 is a flowchart illustrating an example process for generating depth information from one or more images, in accordance with aspects of the present disclosure;

FIG. 6 is a block diagram illustrating an example of a deep learning network, in accordance with some examples;

FIG. 7 is a block diagram illustrating an example of a convolutional neural network, in accordance with some examples; and

FIG. 8 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the disclosure. However, it will be apparent that various aspects and examples may be practiced without these specific details. The figures and description are not intended to be restrictive.

The ensuing description provides exemplary aspects and examples only, and is not intended to limit the scope, applicability, or configuration of the disclosure. Rather, the ensuing description of the exemplary aspects and examples will provide those skilled in the art with an enabling description for implementing aspects and examples of the disclosure. It should be understood that various changes may be made in the function and arrangement of elements without departing from the scope of the application as set forth in the appended claims.

As noted above, machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some cases, a machine learning system can perform depth prediction based on a single image (e.g., based on receiving a single image as input). Depth prediction based on a single input image can be referred to as monocular depth estimation. Monocular depth estimation can be used for many applications (e.g., XR applications, vehicle applications, etc.). In some cases, monocular depth estimation can be used to perform occlusion rendering, for example based on using depth and object segmentation information to render virtual objects in a 3D environment. In some cases, monocular depth prediction can be used to perform 3D reconstruction, for example based on using depth information and one or more poses to create a mesh of a scene. In some cases, monocular depth prediction can be used to perform collision avoidance, for example based on using depth information to estimate distance(s) to one or more objects.

Depth estimation (e.g., such as monocular depth estimation) can be used to generate three-dimensional content (e.g., such as XR content) with greater accuracy. For instance, monocular depth estimation can be used to generate XR content that combines a baseline image or video with one or more augmented overlays of rendered 3D objects. The baseline image data (e.g., an image or a frame of video) that is augmented or overlaid by an XR system may be a two-dimensional (2D) representation of a 3D scene. A naïve approach to generating XR content may be to overlay a rendered object onto the baseline image data, without compensating for 3D depth information that may be represented in the 2D baseline image data.

Depth information can be obtained from one or more depth sensors which can include, but are not limited to, Time of Flight (ToF) sensors and Light Detection and Ranging (LIDAR) sensors. Depth information can additionally, or alternatively, be obtained as a prediction or estimation that is generated based on an image input, a depth input, etc. Accurate depth information can be used for autonomous and/or self-driving vehicles to perceive a driving scene and surrounding environment, and to estimate the distances between the autonomous vehicle and surrounding environmental objects (e.g., other vehicles, pedestrians, roadway elements, etc.). Accurate depth information is needed for the autonomous vehicle to determine and perform appropriate control actions, such as velocity control, steering control, braking control, etc.

Depth information can be used for extended reality (XR) applications for functions such as indoor scene reconstruction and obstacle detection for users, among various others. Accurate depth information can be needed for improved integration of real scenes with virtual scenes and/or to allow users to smoothly and safely interact with both their real-world surroundings and the XR or VR environment. Depth information can be used in robotics to perform functions such as navigation, localization, and interaction with physical objects in the robot's surrounding environment, among various other functions. Accurate depth information can be needed to provide improved navigation, localization, and interaction between robots and their surrounding environment (e.g., to avoid colliding with obstacles, nearby humans, etc.).

Depth information of a scene or image can be referred to as “sparse” when depth information is available for some, but not all, of the points in the scene or the pixels in the image. Depth information of a scene or image can be referred to as “dense” when depth information is available for all of the points in the scene or the pixels in the image. In some examples, sparse depth information can be obtained (e.g., using a lidar sensor or other ToF sensor) for a subset of pixels in an image captured by a camera associated with the lidar or ToF sensor. For instance, the field of view captured by the depth sensor can be smaller than the field of view captured by the camera. Sparse depth information can include the depth information determined for the subset of pixels in the overlapping field of view between the depth sensor and the camera.

Depth completion is a sub-problem of depth estimation, and is the task of predicting, estimating, or otherwise inferring a dense depth map of a three-dimensional scene given a sparse depth map of the scene as input. In some cases, depth completion can be performed to predict dense pixel-wise depth information from a sparse depth map captured using a depth sensor such as a lidar or other ToF sensor. For instance, depth completion can be performed based on a sparse-to-dense determination, in which the sparse depth map data of the scene is used to estimate or predict depth information for pixels that lack depth information in the sparse depth map data input. In some examples, depth completion can be performed to infer the dense depth map of a three-dimensional scene given an input image (e.g., RGB image, grayscale image, etc.) and a corresponding sparse reconstruction of the input image (e.g., in the form of a sparse depth map, obtained from computational techniques or active sensors such as lidar, structured light sensors, ToF sensors, etc.).

In some examples, existing approaches to performing depth completion may generate erroneous values for visually changing image inputs. For example, when an input RGB image (e.g., corresponding to an input sparse depth map of the same scene) includes image regions with relatively bright colors and/or relatively dark colors, the predicted depth values for pixels that lacked depth information in the sparse depth map input can be erroneous. There is a need for systems and techniques that can be used to more accurately perform depth completion for an input image and sparse depth map pair. For example, there is a need to perform accurate depth completion given an input image with low contrast regions, bright color regions, dark color regions, etc. There is also a need for systems and techniques that can be used to perform depth completion to generate completed depth maps with sharper and more distinctive boundaries between different depth values determined for the scene represented in the input image.

Systems, apparatuses, processes (also referred to as methods), and computer-readable media (collectively referred to as “systems and techniques”) are described herein for performing depth completion based on segmentation information and sparse depth information of an input image of a scene. For example, a graph-based neural network can generate a dense depth map based on performing depth completion using as input a segmentation map determined for an image of a scene and a coarse depth map determined for sparse depth measurements of the scene. The sparse depth measurements can be associated with a subset of pixels of a plurality of pixels included in the image of the scene (e.g., and/or included in the segmentation map determined for the image of the scene). The image of the scene can be an RGB image, a grayscale image, etc.

The sparse depth measurements can also be referred to as a sparse depth map. The sparse depth measurements can be obtained using a lidar, a ToF sensor, etc., among various other depth sensors and depth information determination techniques. The sparse depth map can be provided as input to a coarse depth prediction network, which generates as output a coarse depth map that includes depth information for each pixel of the plurality of pixels. For instance, the coarse depth prediction network can be a machine learning network used to predict a depth value for each pixel in the sparse depth map that is not associated with a measured depth value.

The segmentation map can be obtained using a segmentation machine learning network. For instance, the segmentation machine learning network can be used to perform object segmentation and/or semantic segmentation for an input image of a scene, wherein the segmentation machine learning network receives the image of the scene as input and generates the segmentation map as output. Image semantic segmentation is a task of generating segmentation results for a frame of image data, such as a still image or photograph. Video semantic segmentation is a type of image segmentation that includes a task of generating segmentation results for one or more frames of a video (e.g., segmentation results can be generated for all or a portion of the image frames of a video). Image semantic segmentation and video semantic segmentation can be collectively referred to as “image segmentation” or “image semantic segmentation.” Segmentation results can include one or more segmentation masks generated to indicate one or more locations, areas, and/or pixels within a frame of image data that belong to a given semantic segment (e.g., a particular object, class of objects, etc.). For example, each pixel of a segmentation mask can include a value indicating a particular semantic segment (e.g., a particular object, class of objects, etc.) to which each pixel belongs.

In some examples, features can be extracted from an image frame and used to generate one or more segmentation masks for the image frame based on the extracted features. In some cases, machine learning can be used to generate segmentation masks based on the extracted features. For example, a convolutional neural network (CNN) can be trained to perform semantic image segmentation by inputting into the CNN many training images and providing a known output (or label) for each training image. The known output for each training image can include a ground-truth segmentation mask corresponding to a given training image. In some cases, image segmentation can be performed to segment image frames into segmentation masks based on an object classification scheme (e.g., the pixels of a given semantic segment all belong to the same classification or class). For example, one or more pixels of an image frame can be segmented into classifications such as human, hair, skin, clothes, house, bicycle, bird, background, etc. In some examples, a segmentation mask can include a first value for pixels that belong to a first classification, a second value for pixels that belong to a second classification, etc. A segmentation mask can also include one or more classifications for a given pixel. For example, a “human” classification can have sub-classifications such as ‘hair,’ ‘face,’ or ‘skin,’ such that a group of pixels can be included in a first semantic segment with a ‘face’ classification and can also be included in a second semantic segment with a ‘human’ classification.

In some examples, the segmentation map can be obtained using a semantic segmentation machine learning network. For instance, the segmentation map of the image can include different object classifications corresponding to objects represented in the image scene. Each object classification can be associated with a subset of pixels of the image. In some cases, each object classification can be associated with a different subset of pixels of the image. The segmentation map can include distinctive edges between different object classifications that are adjacent to one another within the pixel representation of the image.

In some cases, the systems and techniques can use the graph-based neural network to generate dense depth map outputs based on performing depth completion using a segmentation map input and a sparse depth map input, wherein the segmentation map and sparse depth map correspond to or are otherwise associated with a same three-dimensional scene. In some examples, the sparse depth map can be used to generate a coarse depth map that includes a measured depth value (e.g., included in the sparse depth map input) or a predicted depth value (e.g., predicted by a coarse depth prediction network) for each pixel of a plurality of pixels included in an input image associated with the segmentation map. In some cases, the segmentation map may also be referred to as an image input. In some cases, the sparse depth map and/or the coarse depth map can be referred to as a depth input. In some examples, the segmentation map, the sparse depth map, and/or the coarse depth map can have the same or similar pixel dimensions and/or resolution. The sparse depth map can include depth information for a subset of the pixels represented in the sparse depth map. The coarse depth map can include depth information for each pixel represented in the coarse depth map.

In one illustrative example, the systems and techniques can generate a feature input for each pixel of the plurality of pixels represented in an input image. For instance, the feature input for a particular pixel can include the pixel coordinates of the particular pixel (e.g., x,y or other two-dimensional coordinates representing a location of the particular pixel in the segmentation map input and/or the sparse depth map input). The feature input can further include a coarse depth map output associated with the particular pixel (e.g., such as an estimated coarse depth for the particular pixel), one or more depth uncertainty values, and one or more segmentation map class probabilities associated with the particular pixel.

Nodes of the graph-based neural network can correspond to one or more pixels and the corresponding feature input for each respective pixel of the one or more pixels. For instance, nodes of the graph-based neural network can correspond to a sliding window of adjacent pixels (e.g., each node of a plurality of nodes associated with the graph-based neural network can be associated with a set of pixel features determined for a corresponding sliding window of pixels). The graph nodes of pixel depth and segmentation features can be used as input to the graph-based neural network, which uses message-passing among the graph nodes to generate an interpolated output of depth predictions (e.g., the dense depth map based on depth completion).

Various aspects of the present disclosure will be described with respect to the figures.

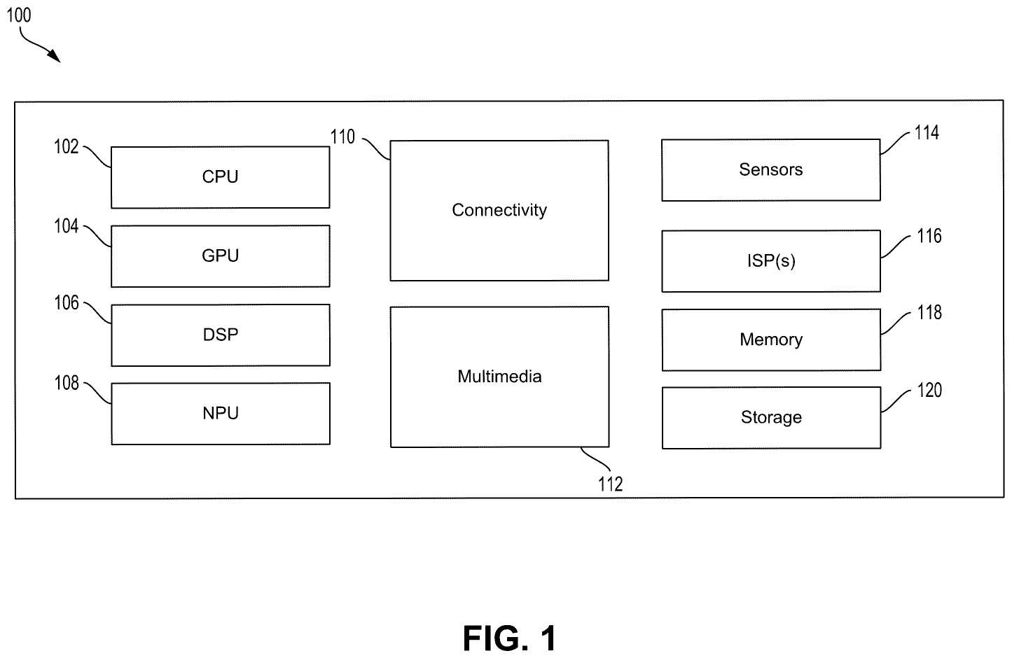

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform depth completion according to aspects of the present disclosure. In some cases, by using a graph-based neural network with a segmentation input and a depth input each associated with a same image, aspects of the present disclosure can increase the accuracy and efficiency of generating dense depth maps from an image input and a sparse depth input.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

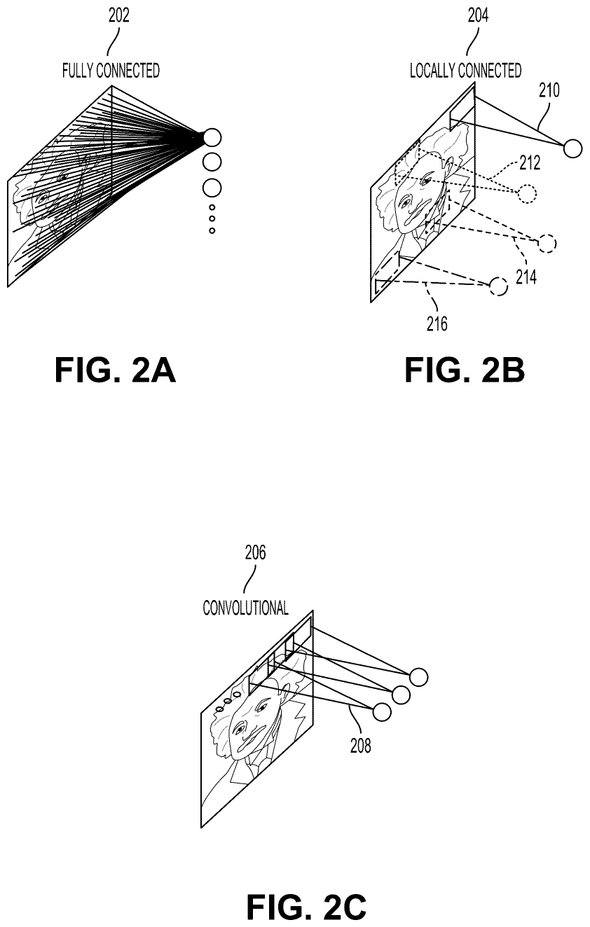

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

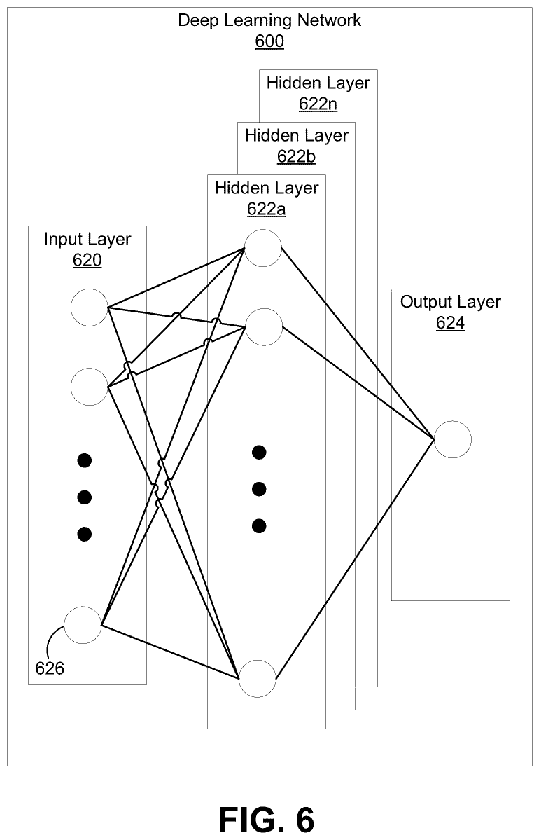

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure. An illustrative example of a deep learning network is described in greater depth with respect to the example block diagram of FIG. 6. An illustrative example of a convolutional neural network is described in greater depth with respect to the example block diagram of FIG. 6.

As mentioned previously, the systems and techniques described herein can be used to generate a dense depth map based on an image input and a depth input. In one illustrative example, the image input and the depth input can be used to generate the dense depth map using a graph neural network (GNN). For instance, the GNN can generate the dense depth map based on performing depth completion using the image input and the depth input. In some aspects, the image input can be a segmentation map corresponding to an image (e.g., RGB image, grayscale image, etc.). In some cases, the depth input can be a coarse depth map corresponding to the same image as the segmentation map. The coarse depth map can be generated based on sparse depth information corresponding to the image (or a portion of the image and/or one or more objects in the image). The sparse depth map can include depth information for a subset of the pixels represented in the segmentation map (e.g., based on the sparse depth map and the segmentation map corresponding to the same scene and having same or similar pixel dimensions). The coarse depth map (e.g., generated based on the sparse depth map) can include measured depth values for the same subset of pixels that are represented in the sparse depth map. The remaining pixels of the depth map (e.g., which do not have measured depth values in the sparse depth map) can be predicted, estimated, or inferred to generate the coarse depth map, as will be described in greater depth below.

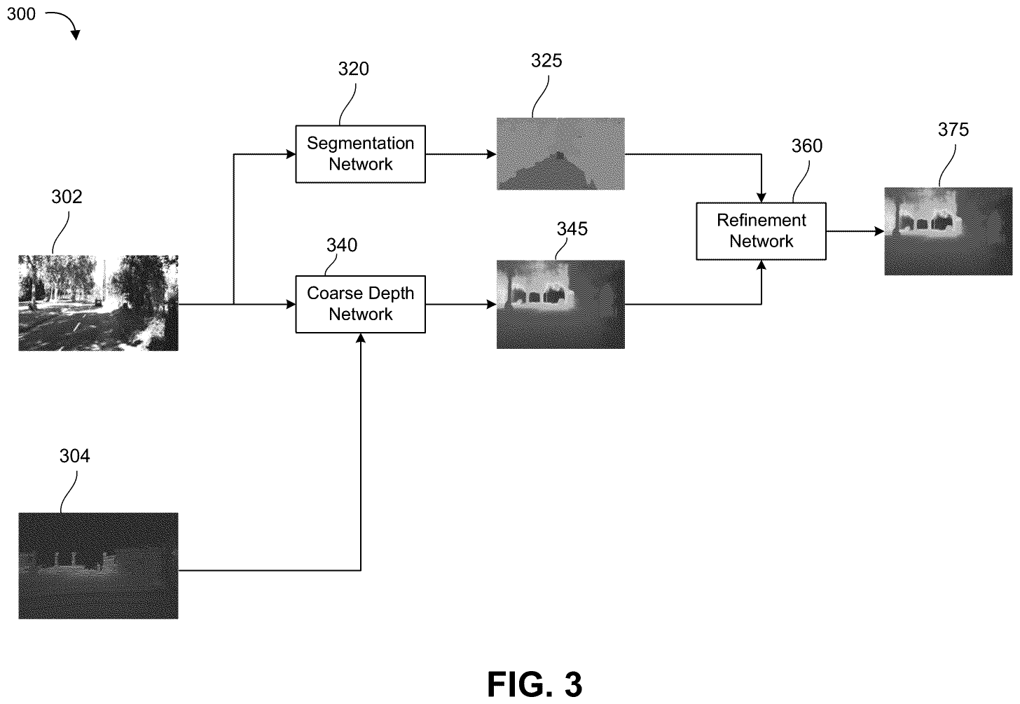

FIG. 3 is a diagram illustrating an example of a machine learning system 300 that can be used to generate a dense depth map using depth completion, in accordance with some examples. In one illustrative example, the machine learning system 300 can include a segmentation network 320, a coarse depth network 340, and a refinement network 360.

The segmentation network 320 can be a segmentation machine learning network (e.g., neural network, such as an RNN or CNN, etc.). The segmentation network 320 can generate segmentation information associated with an image of a scene. For instance, the segmentation network 320 can generate a segmentation map 325 based on receiving as input an image 302. In some cases, the input image 302 can be an RGB or other color image, can be a grayscale image, etc. In some aspects, the segmentation network 320 can be implemented using various pre-trained machine learning segmentation networks.

The coarse depth network 340 can be a coarse depth prediction machine learning network. For example, the coarse depth network 340 can be used to obtain depth information associated with one or more objects in scene of the image 302. In one illustrative example, the coarse depth network 340 can be used to generate a coarse depth map 345, which includes a plurality of pixels having the same resolution as the segmentation map 325 and/or having the same resolution as the input image 302. In some aspects, the input image 302, the segmentation map 325 (e.g., generated by segmentation network 320), and the coarse depth map 345 (e.g., generated by the coarse depth network 340) can each include a plurality of pixels having the same resolution. In such examples, the position of a given pixel in each one of the input image 302, segmentation map 325, and coarse depth map 345 can be the same as or otherwise correspond to the position of a respective pixel in the remaining two of the input image 302, segmentation map 325, and coarse depth map 345.

In one illustrative example, coarse depth network 340 can generate the coarse depth map 345 using as input the image 302 (e.g., the same input image used to generate the segmentation map 325 using the segmentation network 320) and a sparse depth map 304. In some cases, the sparse depth map 304 can include a plurality of pixels and may also have the same resolution as the input image 302, the segmentation map 325, and/or the coarse depth map 345. The position of a given pixel in the sparse depth map 304 can be the same as or otherwise correspond to the position of the same given pixel in each of the input image 302, the segmentation map 325, and the coarse depth map 345. In some examples, the sparse depth map 304 can include depth measurement values for only a subset of the plurality of pixels included in sparse depth map 304. For instance, sparse depth map 304 can include depth measurement values for a subset of pixels that correspond to one or more objects in the scene of image 302 for which depth measurements were obtained using, for example, one or more lidars, ToF sensors, and/or various other depth sensors.

A second subset of pixels in sparse depth map 304 can include a zero value or can include a null value, indicating that a depth measurement was not obtained or is otherwise unavailable for the location in the scene corresponding to each respective pixel of the second subset of pixels in sparse depth map 304. In one illustrative example, the coarse depth network 340 can perform depth completion for sparse depth map 304 to generate a predicted or estimated depth measurement value for each pixel of the second subset of pixels in sparse depth map 304 (e.g., for each pixel for which a measured depth value is not included in the sparse depth map 304). Coarse depth network 340 generates as output the coarse depth map 345, which includes either a measured depth value or an estimated depth value for each pixel of the plurality of pixels in the resolution shared across the inputs and outputs shown in FIG. 3. For instance, the coarse depth map 345 can include the same measured depth values at the same pixel locations as represented in the sparse depth map 304 (e.g., pixels with measured depth values in sparse depth map 304 can be associated to the same respective measured depth values in the output coarse depth map 345). The coarse depth map 345 can include estimated depth values for each pixel having a zero or null value in the sparse depth map 304 (e.g., pixels for which a depth value was not provided in the sparse depth map input 304).

As mentioned previously, in some cases, depth completion can be performed to predict dense pixel-wise depth information from a sparse depth map captured using a depth sensor such as a lidar or other ToF sensor. For instance, depth completion can be performed based on a sparse-to-dense determination, in which the sparse depth map data of the scene is used to estimate or predict depth information for pixels that lack depth information in the sparse depth map data input. In some examples, depth completion can be performed to infer the dense depth map of a three-dimensional scene given an input image (e.g., RGB image, grayscale image, etc.) and a corresponding sparse reconstruction of the input image (e.g., in the form of a sparse depth map, obtained from computational techniques or active sensors such as lidar, structured light sensors, ToF sensors, etc.). As also mentioned previously, a coarse depth completion may generate erroneous values for one or more pixels, pixel locations, and/or portions of the input resolution (e.g., the same resolution that is shared across the input image 302 and sparse depth map 304 provided as input to coarse depth network 340 for performing depth completion).

In one illustrative example, the machine learning system 300 can include a refinement network 360 for generating a refined depth map 375 based on the coarse depth map 345 and the segmentation map 325. For instance, the refinement network 360 can be a graph-based neural network that uses both semantic information (e.g., the semantic segmentation map 325) and depth information (e.g., the coarse depth map 345) to generate a depth completion output (e.g., the refined depth map 375). In some examples, the refinement network 360 can be implemented using a graph neural network (GNN). In some aspects, the refinement network 360 can be implemented using a windowed GNN and a sliding window over the plurality of pixels included in the shared resolution across the segmentation map 325 and the coarse depth map 345.

In some aspects, the GNN refinement network 360 can use absolute position information and/or relative position information of one or more pixels for which depth information is available (e.g., measured depth information from sparse depth map 304 and/or predicted depth information from coarse depth map 345) to perform depth completion using contextual information. For instance, the contextual information can be based on an object classification (e.g., a segmentation of the segmentation map) associated with a particular depth value of the set of sparse depth values (e.g., of the sparse depth map). In some examples, the systems and techniques can use the graph-based neural network to generate a dense depth map output that includes depth information (e.g., a depth value) for each pixel of a plurality of pixels represented in the dense depth map. For example, the systems and techniques can use the graph-based neural network to interpolate and/or extrapolate depth information, semantics information, and/or positional information for a particular pixel based on the surrounding pixels associated with the particular pixel.

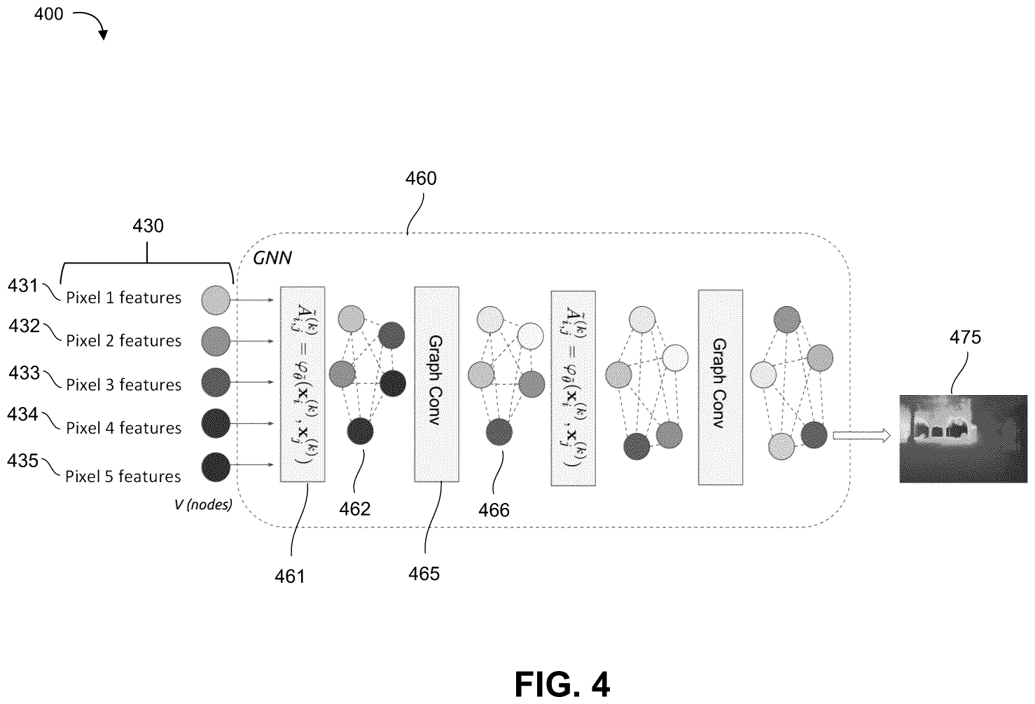

For example, FIG. 4 is a diagram illustrating an example of a graph neural network (GNN) system 400 that can be used as a refinement network for depth completion. In one illustrative example, the GNN system 400 can include a GNN 460 that may be the same as or similar as the refinement network 360 of FIG. 3. The GNN 460 of FIG. 4 can generate as output a refined depth map 475 that may be the same as or similar to the refined depth map 375 of FIG. 3.

The GNN 460 can be implemented using a plurality of graph nodes, where each graph node represents and corresponds to a single pixel (e.g., of a plurality of pixels of an input image or map). For instance, a particular pixel can be represented as a graph node with edges connected to the graph nodes corresponding to the adjacent pixels of the particular pixel. For instance, an image of resolution 32×32×3 (e.g., 32 pixels in width, 32 pixels in height, 3 channels), a graph representation may have 3,072 nodes and 1,984 edges. The GNN 460 can generate the output refined depth map 475 by performing message passing, aggregation, and updating operations over a plurality of nodes 430 corresponding to the plurality of pixels included in the input to the GNN 460. The message passing, aggregation, and updating operations can be performed at each layer of GNN 460, which can include one or more such layers between its input and output.

In one illustrative example, the GNN 460 can receive as input a plurality of graph nodes 430, with each graph node of the plurality of graph nodes 430 corresponding to a particular pixel included in the plurality of pixels (and resolution) common to both the segmentation map 325 and the coarse depth map 345 that are provided as input to the refinement network 360 of FIG. 3 (e.g., wherein GNN 460 of FIG. 4 can be used to implement the refinement network 360 of FIG. 3). For instance, the quantity of graph nodes 430 can be the same as the quantity of pixels included in segmentation map 325, which can be the same as the quantity of pixels included in coarse depth map 345. For example, FIG. 4 depicts an input quantity of graph nodes 430 equal to five (e.g., a first graph node 431 corresponding to pixel 1 features, a second graph node 432 corresponding to pixel 2 features, . . . , etc.). In this example, the five graph nodes 430 correspond to an input comprising a segmentation map (e.g., such as segmentation map 325 of FIG. 3) having five pixels arranged in a resolution and a coarse depth map (e.g., such as coarse depth map 345 of FIG. 3) having five pixels arranged in the same resolution.

In one illustrative example, each respective graph node of the plurality of graph nodes 430 can include pixel features that combine pixel location information (e.g., in the shared or common resolution), coarse depth prediction information (e.g., from the coarse depth map 345), and segmentation class probability information (e.g., from the segmentation map 325). For instance, a given graph node feature i, corresponding to the i-th pixel of the plurality of pixels, can be determined as:

$$Feature i = [ x , y , {d}_{i} , u , [ {p}_{i , 1} , {p}_{i , 2} , … , {p}_{i , c} ] ] .$$

Here, x and y represent a two-dimensional coordinate of the particular pixel i, for example defined such that an origin point (0,0) corresponds to a known pixel position such as one of the four corners or the center of the image or maps (e.g., segmentation map 325, coarse depth map 345) used to generate the graph node features. The value dᵢ can represent the estimated coarse depth for the particular pixel i, for example determined as the depth value corresponding to the particular pixel i in the coarse depth map 345. As noted previously, the estimated coarse depth dᵢ can be a measured depth value (e.g., from sparse depth map 304) when the particular pixel i corresponds to a location in the scene of the image (e.g., image 302) that was measured using a lidar, ToF sensor, or other depth sensor. The estimated coarse depth dᵢ can be an estimated value when the particular pixel i corresponds to a location in the scene of the image that was not measured in the sparse depth map 304 but was instead estimated in the coarse depth map 345 (e.g., estimated by coarse depth network 340).

The value u can represent one or more depth uncertainty values associated with the estimated coarse depth dᵢ and will be described in greater depth below. The values [p_{i,1}, p_{i,2}, . . . , p_{i,c}] represent the segmentation class probabilities associated with the particular pixel i and may be determined as the c different segmentation class probabilities associated to the particular pixel i in the segmentation map input 325. In some cases, a graph node feature can include all of the c different segmentation class probabilities of segmentation map 325. In some instances, a graph node feature can include a subset of the c different segmentation class probabilities of segmentation map 325, such as the top one probability for the particular pixel i, the top three probabilities for the particular pixel i, etc.

In some aspects, the GNN 460 can be a windowed GNN 460 and/or can utilize as input a subset of graph nodes (e.g., of the plurality of graph nodes corresponding to the plurality of pixels) based on applying a sliding window to the pixels (e.g., of the plurality of pixels included in the resolution of the segmentation map 325 and the coarse depth map 345). For example, the sliding window can include a pre-determined quantity of pixels arranged in a pre-determined shape. In some examples, the sliding window can be a horizontal sliding window, for example including five adjacent (e.g., consecutive) pixels in a same row of the plurality of pixels arranged in the resolution. In some cases, the sliding window can be a vertical sliding window, for example including five adjacent (e.g., consecutive) pixels in a same column of the plurality of pixels arranged in the resolution. In one illustrative example, the windowed GNN 460 can be utilized during inference to determine a refined depth measurement output for each respective pixel included in the plurality of pixels arranged in the resolution. For instance, given a sliding window that includes five different pixels, a refined depth measurement output can be determined based on providing as input to the windowed GNN 460 an input comprising the graph node feature i corresponding to the particular pixel and the four graph node features i corresponding to the four adjacent pixels included in the sliding window for the particular pixel. Based on an adjacency matrix A (e.g., shown in FIG. 4 as the adjacency matrix layer 461 and the adjacency matrix graph representation 462) and a graph convolution 465 that are applied in each layer of the windowed GNN 460 to the subset of graph nodes received as input, the windowed GNN 460 can use message passing among the graph nodes to generate as output an interpolated output of depth predictions for each pixel (e.g., each pixel position) of the plurality of pixels included in the input resolution of coarse depth map 345 (e.g., which is the same as the plurality of pixels included in the input resolution of segmentation map 425, which is also the same as the plurality of pixels included in the input resolution of image 302 and sparse depth map 304). The interpolated output of depth predictions for each pixel can be used to generate the refined depth map 475, having the same quantity of pixels and the same resolution as the coarse depth map 345.

In some aspects, the GNN 460 and/or the GNN system 400 of FIG. 4 can be trained using one or more of L1 loss, L2 loss, Huber loss, and/or Berhu loss on the output node depth predictions with respect to the ground truth. For instance, given ground truth depth information for each pixel of a plurality of pixels, one or more losses can be determined between the interpolated output depth prediction for a particular pixel and the ground truth depth information for the particular pixel, with the one or more losses used to drive training of the GNN 460 and/or the GNN system 400 of FIG. 4.

As mentioned previously, each graph node feature can be generated to include one or more depth uncertainty values, u. For instance, the depth uncertainty value(s) u (e.g., collectively referred to as depth uncertainty value u) can be indicative of one or more measures of uncertainty associated with the depth information obtained from coarse depth map 345 for a particular pixel corresponding to the graph node feature. For example, depth information obtained from the coarse depth map 345 for pixels that are associated with lidar or ToF-measured depth information in the sparse depth map 304 can be assumed to be accurate and can be assigned an uncertainty value u equal to zero.

In some examples, the depth uncertainty u can be determined as one or more calculated values. For example, calculated depth uncertainty values u can be determined for depth information obtained from the coarse depth map 345 for pixels that are not associated with lidar or ToF-measured depth information in the sparse depth map 304 (e.g., pixels for which the depth information in coarse depth map 345 was estimated or predicted by coarse depth prediction network 340). In one illustrative example, the uncertainty value u can be determined using Monte-Carlo dropout on the coarse depth prediction network 340 to obtain a variance of predicted depth values. The variance of predicted depth values, u_{d}, can be used as the uncertainty value u.

In another illustrative example, Monte-Carlo dropout can be used on the segmentation network 320 to determine a variance of predicted segmentation classifications (e.g., a variance of classifications over the c different segmentation classifications that may be included in the segmentation map 325 and/or may be included in the graph node features, as described above). In such examples, the variance of predicted segmentation classes, uₛ, can be used as the uncertainty value u.

In some cases, a boundary map can be determined based on the segmentation map 325. For instance, a boundary map can be extracted from segmentation map 325, wherein the boundary map is indicative of boundaries (e.g., edges) between different segmentations, segmentation masks, and/or segmentation classifications represented in the segmentation map 325. The predicted depth value uncertainty u for a graph node feature associated with a particular pixel can be determined based on a distance transform of the particular pixel from one or more boundaries in the boundary map. For instance, if the particular pixel is associated with a first segmentation classification in the segmentation map 325, a distance transform of the particular pixel from the boundary of the first segmentation classification in the segmentation map 325 can be determined. In some cases, the distance transform can be a distance transform of the particular pixel from the nearest boundary of the first segmentation classification, such as the nearest boundary (e.g., relative to the position of the particular pixel) where the first segmentation classification forms and edge with a different, second segmentation classification in the segmentation map 325. In one illustrative example, the predicted depth uncertainty value u for the particular pixel can be determined based on an exponential of the negative distance and can be represented as u_{b}. In some aspects, the exponential negative distance transform value, u_{b}, can be utilized based on an assumption that boundaries between different segmentation classifications in the segmentation map 325 represent the regions of greatest uncertainty for depth estimation.

In some aspects, one or more (or all) of the predicted depth uncertainty values u described above can be aggregated through learnable weights. For instance, each graph feature for a particular pixel can include a plurality of different predicted depth uncertainty values u, which are individually trained during training of the GNN 460. In some cases, different ones (or all) of the predicted depth uncertainty values u described above can be aggregated using a root mean square (RMS) aggregation of u²=u_{d}²+uₛ²+u_{b}², with the RMS aggregation value u² being included in the graph node features generated for some (or all) of the pixels in the plurality of pixels.

In some aspects, additional semantic information (e.g., including prior knowledge) of relationships between pixels can be included as respective loss terms during training of the GNN 460. For instance, semantic information of the segmentation outputs (e.g., of the segmentation map 325) can be used to guide depth prediction and training thereof. For example, for pixels classified as belonging to a “sky” class of the segmentation, additional semantic information can be knowledge that the depth values of each pixel belonging to the “sky” class should be the same. In this example, a loss (dᵢ−dⱼ)² can be applied and utilized during training of GNN 460 to enforce and propagate this additional semantic information, wherein dᵢ represents the depth value of a pixel i belonging to the “sky” class and dⱼ represents the depth value of a pixel j belonging to the “sky” class. During training of GNN 460, the use of the loss term (dᵢ−dⱼ)² drives GNN 460 to learn to generate refined depth value outputs (e.g., the pixel-level refined depth value outputs used to generate the refined depth map 475) that minimize the difference in depth value between pixels belonging to the “sky” class (and/or to minimize the difference in depth value between pixels belonging to various other segmentation classes augmented with additional semantic information indicating that all pixels of the given segmentation class should have the same depth value).

In another example, additional semantic information can be indicative of one or more relationships between the depth values associated with pixels of a first semantic segmentation class and the depth values associated with pixels of a second semantic segmentation class. For instance, the depth values of pixels in the “sky” class should be greater than the depth values of pixels from other classes. In this example, an additional loss term (e.g., penalty) can be utilized during training of GNN 460, given by (dᵢ−dₖ−D²). Here, dᵢ is the depth value of a pixel i belonging to the “sky” class, dₖ is the depth value of a pixel k belonging to a non-“sky” class, and D is a constant barrier.

In some aspects, the graph node feature given by Feature i=[x, y, dᵢ, u, [p_{i,1}, p_{i,2}, . . . , p_{i,c}]] can utilize a positional encoding of the two-dimensional pixel position [x, y]. For example, the two-dimensional pixel position coordinates x and y can be replaced in the graph node feature with a positional encoding of each respective pixel. In some cases, pixel position can be encoded based on patches of pixels. In some examples, patches of pixels can represent groups of pixels along a same column, along a same row, etc. In one illustrative example, the plurality of pixels can be divided into pixel patches based on columns. For example, each column of pixels that is included in the plurality of pixels can comprise a patch, with each column of pixels associated with a different position value (e.g., a first column of pixels can be associated with a first patch having a position value=0; a second column of pixels can be associated with a second patch having a position value=1; etc.). In some cases, the respective pixels included in a same patch (e.g., included in a same column of pixels) can each be associated with a different index (e.g., such as a row index). In one illustrative example, a pixel positional encoding PE can be given as:

$$P {E}_{( pos , 2 i )} = sin ( \frac{p o s}{1000 {0}^{\frac{2 i}{d}}} )$$

Here, pos can represent the position value identifying the pixel patch that includes a particular pixel (e.g., the column of the particular pixel). The value i can represent the index of the particular pixel within the pixel patch (e.g., the row of the particular pixel). The value d can represent the size of the pixel patch (e.g., the total quantity of pixels included in the pixel patch). In another example, a group of pixels in a patch may each be associated with the same positional encoding.

As mentioned previously, the graph node feature can include one or more (or all) of the c different segmentation classification probabilities associated with the particular pixel (e.g., the segmentation classification probabilities [p_{i,1}, p_{i,2}, . . . , p_{i,c}] included in the graph node feature). In some cases, the graph node features can be generated to directly include a respective probability for each segmentation classification of the c segmentation classifications. In some aspects, the quantity of segmentation classification probabilities included in a graph node feature can be less than the total quantity, c, of different segmentation classifications included in the segmentation map 325. For instance, one or more distinctions between different segmentation classifications may not be needed for determining depth using GNN 460. For example, a “door” classification and a “wall” classification can be treated as the same classification for purposes of depth determination performed by GNN 460. In another example, the quantity of classifications used to generate the graph node features can be reduced, relative to a larger quantity of classifications output by or otherwise utilize by the segmentation map 325, based on clustering of semantically similar classes into combined classes. In some cases, the semantically similar classes can be clustered manually. In some examples, the semantically similar classes can be determined based on automatic clustering of the features (e.g., using one or more machine learning networks and/or using GNN 460). In some cases, clustering can be determined using three-dimensional feature maps of a plurality of input images (e.g., such as image 302) that are included in a set of training data inputs used to train GNN 460. For instance, each training data input can include an input image (e.g., such as image 302), an input sparse depth map (e.g., such as sparse depth map 304), and a ground-truth refined depth map (e.g., similar to the refined depth map 375 of FIG. 3 and/or the refined depth map 475 of FIG. 4). The plurality of input images in a training data set can be clustered based on collecting the respective logits associated with each input image, for example by applying hierarchical clustering and/or spectral clustering to the plurality of logits. The hierarchical clustering and/or spectral clustering of the logits of the plurality of training data input images can be used to group different semantic segmentation classifications that are close to one another in distance value measurements into a higher group and/or can be used to group different semantic segmentation classifications that are farther from one another in distance value measurements into a lower group.

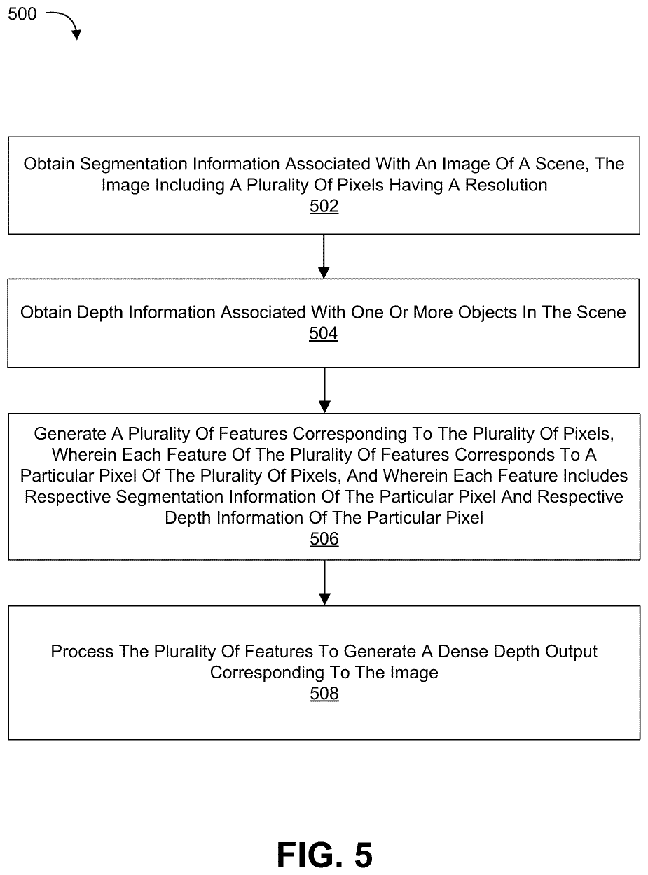

FIG. 5 is a flowchart illustrating an example process 500 for generating depth information from one or more images using one or more of the techniques described herein. The process 500 can be performed by a computing device (or apparatus), or a component of the computing device (e.g., a chipset, a processor such as a neural processing unit (NPU), a digital signal processor (DSP), etc.), utilizing or implementing the neural network model (e.g., the neural network system 300 of FIG. 3, the neural network system of FIG. 4, etc.).

At block 502, the process 500 can include obtaining segmentation information associated with an image of a scene, the image including a plurality of pixels having a resolution. For example, the segmentation information can include a segmentation map of the image, the segmentation map having the resolution. In some examples, obtaining the segmentation information comprises obtaining an image of a scene (e.g., such as the image 302 of FIG. 3) and generating, using a segmentation machine learning network, the segmentation map based on the image of the scene. For example, the segmentation map can be the same as or similar to the segmentation map 325 generated by the segmentation network 320 of FIG. 3.

At block 504, the process 500 can include obtaining depth information associated with one or more objects in the scene. For example, the depth information can include a coarse depth map comprising a plurality of locations having the resolution. In some examples, the coarse depth map can be the same as or similar to the coarse depth map 345 of FIG. 3. In some examples, each location of the plurality of locations in the coarse depth map includes a value representing a respective measured depth or a respective predicted depth of a pixel having a corresponding location in the image.

In some cases, the depth information can be obtained based on a sparse depth map. The sparse depth map can be the same as or similar to the sparse depth map 304 of FIG. 3. For example, the sparse depth map can be associated with one or more objects in the scene, and can comprise a plurality of locations having the resolution. In some examples, a coarse depth prediction machine learning network can be used to generate the coarse depth map based on the sparse depth map and the image of the scene. For example, the coarse depth map 345 of FIG. 3 can be generated using the coarse depth network 340, based on the sparse depth map 304 and the image of the scene 302.

In some cases, each location of a first subset of locations of the plurality of locations in the sparse depth map can include a value representing a respective depth of a respective pixel having a corresponding location in the image. For example, the sparse depth map 304 of FIG. 3 can include depth values for some, but not all, of the pixels in the sparse depth map 304. In some aspects, each location of a second subset of locations of the plurality of locations in the sparse depth map includes a zero-value corresponding to a lack of depth information for a respective pixel having a corresponding location in the image. For example, a subset of locations in sparse depth map 304 of FIG. 3 can include a zero-value when depth information is not available for that subset of locations.

At block 506, the process 500 can include generating a plurality of features corresponding to the plurality of pixels, wherein each feature of the plurality of pixels corresponds to a particular pixel of the plurality of pixels, and wherein each feature includes respective segmentation information of the particular pixel and respective depth information of the particular pixel. For example, the plurality of features can be the same as or similar to the plurality of features 430 depicted in FIG. 4. The features can correspond to a particular pixel, such as the features 431 of FIG. 4 corresponding to a pixel 1, the features 432 of FIG. 4 corresponding to a pixel 2, the features 433 of FIG. 4 corresponding to a pixel 3, etc.

In some cases, each feature of the plurality of features further includes a depth uncertainty value associated with the respective depth information of the particular pixel. The depth uncertainty value can be zero based on the respective depth information of the particular pixel comprising a measured depth from the coarse depth map (e.g., coarse depth map 345 of FIG. 3). A measured depth from coarse depth map 345 can correspond to a measured depth obtained from the sparse depth map 304 of FIG. 3. In some cases, the depth uncertainty value can be a calculated uncertainty based on the respective depth information comprising a predicted depth from the coarse depth map. For example, a predicted depth from coarse depth map 345 of FIG. 3 can correspond to a predicted depth value generated by the coarse depth network 340 of FIG. 3 (e.g., for a location in which measured depth information was unavailable in sparse depth map 304 of FIG. 3).

In some examples, the calculated uncertainty can be determined based on determining a variance of a plurality of predicted depths from the coarse depth map 345 of FIG. 3. In some examples, the calculated uncertainty can be determined based on determining a variance of class predictions from a segmentation map associated with the image (e.g., such as the segmentation map 325 generated using the segmentation network 320 of FIG. 3).

In some cases, each feature of the plurality of features (e.g., the plurality of features 430 of FIG. 4) includes a coarse depth estimation for a pixel of the plurality of pixels and one or more segmentation class probabilities associated with the pixel. In some examples, each feature of the plurality of features (e.g., the plurality of features 430 of FIG. 4) further includes pixel coordinate information of a position of the particular pixel in the image. Pixel coordinate information can be indicative of a coordinate of a particular pixel with respect to the resolution and/or can be indicative of a coordinate (e.g., (x,y) coordinate) of the particular pixel.

In some examples, each feature of the plurality of features further includes positional information indicative of a position of the particular pixel in the image. For example, the positional information can be a positional encoding indicative of pixel coordinate information of the position of the particular pixel in the image. In some cases, each pixel of the plurality of pixels is associated with a respective patch of a plurality of patches, the respective patch including a subset of the plurality of pixels. In some examples, the positional information is a positional encoding indicative of the respective patch associated with the particular pixel and a position of the particular pixel in the respective patch. For example, the respective patch can include pixels in a same column of the image and the position of the particular pixel in the respective patch can comprise or be indicative of a row index. In some cases, each feature of the plurality of features further includes an uncertainty value associated with the respective depth information of the particular pixel.

At block 508, the process 500 includes processing the plurality of features to generate a dense depth output corresponding to the image. In some cases, the process 500 includes using a graph neural network to process the plurality of features to generate the dense depth output corresponding to the image. For example, the graph neural network can be the same as or similar to the refinement network 360 of FIG. 3 and the dense depth output can be the same as or similar to the refined depth map 375 of FIG. 3. In some cases, the graph neural network can be the same as or similar to the graph neural network (GNN) 460 of FIG. 4 and the dense depth output can be the same as or similar to the refined depth map 475 of FIG. 4. In some cases, the graph neural network can be a windowed graph neural network.

In some cases, the process 500 includes determining contextual information associated with at least one location of the plurality of locations. The contextual information can be indicative of an absolute pixel location of the at least one location or indicative of a relative pixel location of the at least one location. In some cases, the contextual information is further indicative of an object classification associated with a sparse depth value obtained for the at least one location. For example, the object classification can be determined using the segmentation map 325 and/or other object classification information generated by the segmentation network 320 of FIG. 3.

In some cases, a plurality of graph nodes can be generated using the plurality of features. For example, the plurality of graph nodes can be the same as or similar to one or more of the graph nodes 462, 466 of FIG. 4 and/or the plurality of features can be the same as or similar to the plurality of features 430 of FIG. 4. In some example, each graph node of the plurality of graph nodes can include a respective feature of the plurality of features corresponding to a particular pixel of the plurality of pixels.

In some cases, generating the dense depth output (e.g., the refined depth map 375 of FIG. 3 and/or the refined depth map 475 of FIG. 4) comprises determining a predicted depth value for each respective pixel of the plurality of pixels and generating the dense depth output using the predicted depth value for each respective pixel of the plurality of pixels. In some examples, determining the predicted depth value for a pixel of the plurality of pixels can be based on obtaining a respective subset of graph nodes included in the plurality of graph nodes. The respective subset of graph nodes can correspond to the pixel. An adjacency matrix and one or more graph convolution layers of the graph neural network can be used to process the respective subset of graph nodes to generate the predicted depth value for the pixel. For example, the one or more graph convolution layers can be the same as or similar to one or more of the graph convolution layers 465 of the GNN 460 of FIG. 4. In some examples, the respective subset of graph nodes includes a graph node corresponding to the pixel and one or more adjacent graph nodes. Each adjacent graph node can correspond to a pixel of the plurality of pixels that is adjacent to the pixel. In some aspects, the respective subset of graph nodes can be obtained using a sliding window over the plurality of pixels.

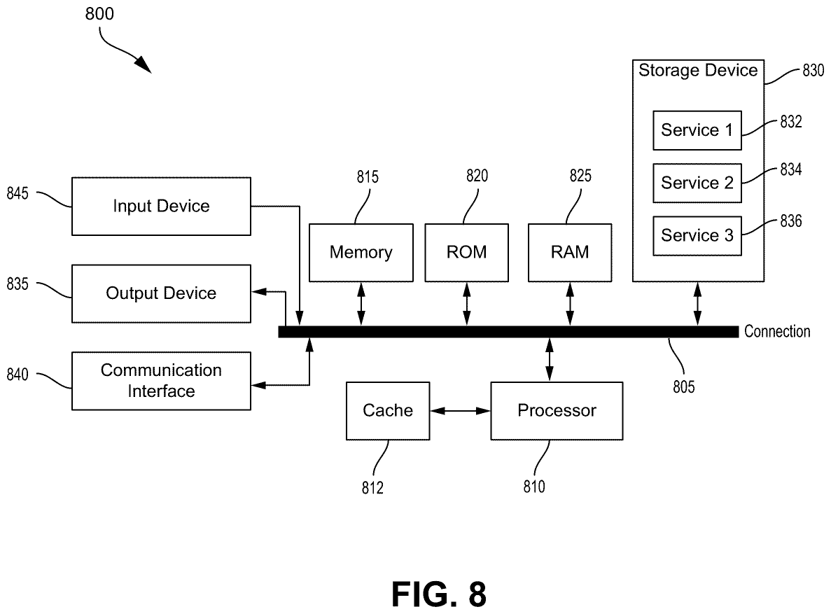

As noted above, the processes described herein (e.g., process 500 and/or any other process described herein) may be performed by a computing device or apparatus utilizing or implementing the neural network model (e.g., the neural network system 300 of FIG. 3, the neural network system 400 of FIG. 4, etc.). In one example, the process 500 can be performed by the electronic device 100 of FIG. 1. In another example, the process 500 can be performed by the computing system having the computing device architecture of the computing system 800 shown in FIG. 8 utilizing or implementing the neural network model (e.g., the neural network system 300 of FIG. 3, the neural network system 400 of FIG. 4, etc.). For instance, a computing device with the computing device architecture of the computing system 800 shown in FIG. 8 can implement the operations of FIG. 5 and/or the components and/or operations described herein with respect to any of FIGS. 3 through 5.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the process 500 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 500 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is an illustrative example of a deep learning neural network 600 that can be used by the neural network system 300 of FIG. 3 and/or the neural network system 400 of FIG. 4. An input layer 620 includes input data. In one illustrative example, the input layer 620 can include data representing the pixels of an input video frame. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 624 that provides an output resulting from the processing performed by the hidden layers 622a, 622b, through 622n. In one illustrative example, the output layer 624 can provide a classification for an object in an input video frame. The classification can include a class identifying the type of object (e.g., a person, a dog, a cat, or other object).

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the hidden layers 622a, 622b, through 622n can transform the information of each input node by applying activation functions to the information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 624, at which an output is provided. In some cases, while nodes (e.g., node 626) in the neural network 600 are shown as having multiple output lines, a node has a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 624. In an example in which the neural network 600 is used to identify objects in images, the neural network 600 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 600 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 600 is trained well enough so that the weights of the layers are accurately tuned.

For the example of identifying objects in images, the forward pass can include passing a training image through the neural network 600. The weights are initially randomized before the neural network 600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 600 can perform a backward pass by determining which inputs (weights) most contributed to the loss of the network, and can adjust the weights so that the loss decreases and is eventually minimized.

A derivative of the loss with respect to the weights (denoted as dL/dW, where Ware the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

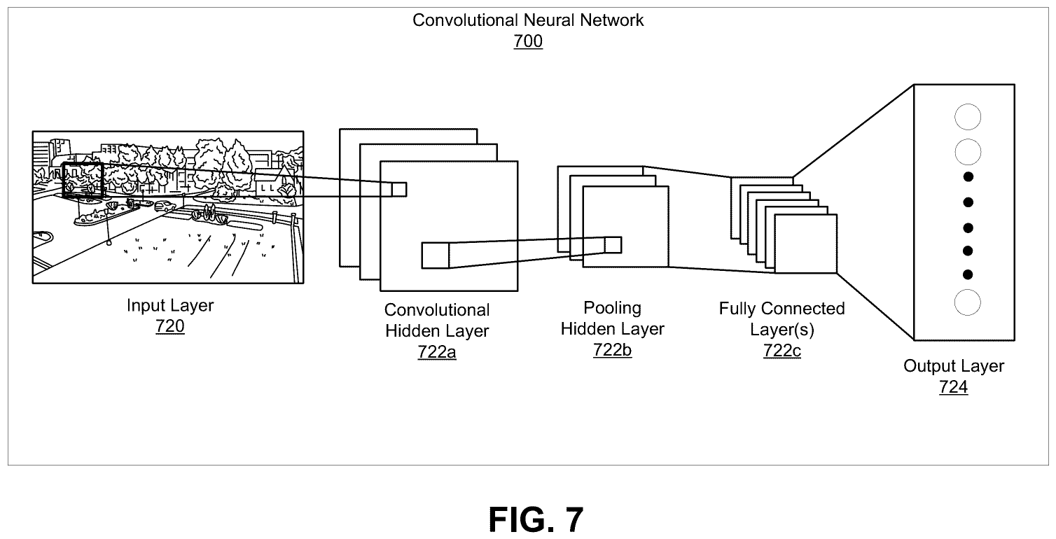

The neural network 600 can include any suitable deep network. One example includes a convolutional neural network (CNN), which includes an input layer and an output layer, with multiple hidden layers between the input and out layers. An example of a CNN is described below with respect to FIG. 7. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

FIG. 7 is an illustrative example of a convolutional neural network 700 (CNN 700). The input layer 720 of the CNN 700 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 722a, an optional non-linear activation layer, a pooling hidden layer 722b, and fully connected hidden layers 722c to get an output at the output layer 724. While only one of each hidden layer is shown in FIG. 7, one of ordinary skill will appreciate that multiple convolutional hidden layers, non-linear layers, pooling hidden layers, and/or fully connected layers can be included in the CNN 700. As previously described, the output can indicate a single class of an object or can include a probability of classes that best describe the object in the image.

The first layer of the CNN 700 is the convolutional hidden layer 722a. The convolutional hidden layer 722a analyzes the image data of the input layer 720. Each node of the convolutional hidden layer 722a is connected to a region of nodes (pixels) of the input image called a receptive field. The convolutional hidden layer 722a can be considered as one or more filters (each filter corresponding to a different activation or feature map), with each convolutional iteration of a filter being a node or neuron of the convolutional hidden layer 722a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 722a. Each connection between a node and a receptive field for that node learns a weight and, in some cases, an overall bias such that each node learns to analyze its particular local receptive field in the input image. Each node of the hidden layer 722a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 722a is due to each node of the convolutional layer being applied to its corresponding receptive field. For example, a filter of the convolutional hidden layer 722a can begin in the top-left corner of the input image array and can convolve around the input image. As noted above, each convolutional iteration of the filter can be considered a node or neuron of the convolutional hidden layer 722a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 722a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 722a.

The mapping from the input layer to the convolutional hidden layer 722a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 722a can include several activation maps in order to identify multiple features in an image. The example shown in FIG. 7 includes three activation maps. Using three activation maps, the convolutional hidden layer 722a can detect three different kinds of features, with each feature being detectable across the entire image.

In some examples, a non-linear hidden layer can be applied after the convolutional hidden layer 722a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 700 without affecting the receptive fields of the convolutional hidden layer 722a.

The pooling hidden layer 722b can be applied after the convolutional hidden layer 722a (and after the non-linear hidden layer when used). The pooling hidden layer 722b is used to simplify the information in the output from the convolutional hidden layer 722a. For example, the pooling hidden layer 722b can take each activation map output from the convolutional hidden layer 722a and generates a condensed activation map (or feature map) using a pooling function. Max-pooling is one example of a function performed by a pooling hidden layer. Other forms of pooling functions be used by the pooling hidden layer 722a, such as average pooling, L2-norm pooling, or other suitable pooling functions. A pooling function (e.g., a max-pooling filter, an L2-norm filter, or other suitable pooling filter) is applied to each activation map included in the convolutional hidden layer 722a. In the example shown in FIG. 7, three pooling filters are used for the three activation maps in the convolutional hidden layer 722a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 722a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 722a having a dimension of 24×24 nodes, the output from the pooling hidden layer 722b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 722b to every one of the output nodes in the output layer 724. Using the example above, the input layer includes 28×28 nodes encoding the pixel intensities of the input image, the convolutional hidden layer 722a includes 3×24×24 hidden feature nodes based on application of a 5×5 local receptive field (for the filters) to three activation maps, and the pooling layer 722b includes a layer of 3×12×12 hidden feature nodes based on application of max-pooling filter to 2×2 regions across each of the three feature maps. Extending this example, the output layer 724 can include ten output nodes. In such an example, every node of the 3×12×12 pooling hidden layer 722b is connected to every node of the output layer 724.

The fully connected layer 722c can obtain the output of the previous pooling layer 722b (which should represent the activation maps of high-level features) and determines the features that most correlate to a particular class. For example, the fully connected layer 722c layer can determine the high-level features that most strongly correlate to a particular class, and can include weights (nodes) for the high-level features. A product can be computed between the weights of the fully connected layer 722c and the pooling hidden layer 722b to obtain probabilities for the different classes. For example, if the CNN 700 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 724 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 8 is a diagram illustrating an example of a system for implementing certain aspects of the present disclosure. In particular, FIG. 8 illustrates an example of computing system 800, which can be for example any computing device making up a computing system, a camera system, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some examples, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for generating depth information from one or more images, the apparatus comprising: at least one memory; and at least one processor coupled to the at least one memory, the at least one processor being configured to: obtain segmentation information associated with an image of a scene, the image including a plurality of pixels having a resolution; obtain depth information associated with one or more objects in the scene; generate a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and process the plurality of features to generate a dense depth output corresponding to the image.

Aspect 2. The apparatus of Aspect 1, wherein: the at least one processor is configured to process, using a graph neural network, the plurality of features to generate the dense depth output corresponding to the image; the segmentation information includes a segmentation map of the image, the segmentation map having the resolution; and the depth information includes a coarse depth map comprising a plurality of locations having the resolution.

Aspect 3. The apparatus of Aspect 2, wherein the at least one processor is further configured to: determine contextual information associated with at least one location of the plurality of locations, the contextual information indicative of an absolute pixel location of the at least one location or indicative of a relative pixel location of the at least one location.

Aspect 4. The apparatus of Aspect 3, wherein the contextual information is further indicative of an object classification associated with a sparse depth value obtained for the at least one location.

Aspect 5. The apparatus of any of Aspects 2 to 4, wherein, to obtain the segmentation information, the at least one processor is configured to: obtain the image of the scene; and generate, using a segmentation machine learning network, the segmentation map based on the image of the scene.

Aspect 6. The apparatus of any of Aspects 2 to 5, wherein each location of the plurality of locations in the coarse depth map includes a value representing a respective measured depth or a respective predicted depth of a pixel having a corresponding location in the image.

Aspect 7. The apparatus of Aspect 6, wherein each feature of the plurality of features further includes a depth uncertainty value associated with the respective depth information of the particular pixel, and wherein: the depth uncertainty value is zero based on the respective depth information comprising a measured depth from the coarse depth map; and the depth uncertainty value is a calculated uncertainty based on the respective depth information comprising a predicted depth from the coarse depth map.

Aspect 8. The apparatus of Aspect 7, wherein, to determine the calculated uncertainty, the at least one processor is configured to: determine a variance of a plurality of predicted depth values from the coarse depth map.

Aspect 9. The apparatus of any of Aspects 7 to 8, wherein, to determine the calculated uncertainty, the at least one processor is configured to: determine a variance of class predictions from the segmentation map of the image.

Aspect 10. The apparatus of any of Aspects 2 to 9, wherein, to obtain the depth information, the at least one processor is configured to: obtain a sparse depth map associated with one or more objects in the scene, the sparse depth map comprising a plurality of locations having the resolution; and generate, using a coarse depth prediction machine learning network, the coarse depth map based on the sparse depth map and the image of the scene.

Aspect 11. The apparatus of Aspect 10, wherein: each location of a first subset of locations of the plurality of locations in the sparse depth map includes a value representing a respective depth of a respective pixel having a corresponding location in the image; and each location of a second subset of locations of the plurality of locations in the sparse depth map includes a zero-value corresponding to a lack of depth information for a respective pixel having a corresponding location in the image.

Aspect 12. The apparatus of any of Aspects 1 to 11, wherein the at least one processor is configured to generate a plurality of graph nodes using the plurality of features, and wherein each graph node of the plurality of graph nodes includes a respective feature of the plurality of features corresponding to a particular pixel of the plurality of pixels.

Aspect 13. The apparatus of Aspect 12, wherein, to generate the dense depth output, the at least one processor is configured to: determine a predicted depth value for each respective pixel of the plurality of pixels; and generate the dense depth output using the predicted depth value for each respective pixel of the plurality of pixels.

Aspect 14. The apparatus of Aspect 13, wherein, to determine the predicted depth value for a pixel of the plurality of pixels, the at least one processor is configured to: obtain a respective subset of graph nodes included in the plurality of graph nodes, the respective subset of graph nodes corresponding to the pixel; and process, using an adjacency matrix and one or more graph convolution layers of a graph neural network, the respective subset of graph nodes to generate the predicted depth value for the pixel.

Aspect 15. The apparatus of Aspect 14, wherein the respective subset of graph nodes includes: a graph node corresponding to the pixel; and one or more adjacent graph nodes, each adjacent graph node corresponding to a pixel of the plurality of pixels that is adjacent to the pixel.

Aspect 16. The apparatus of any of Aspects 14 to 15, wherein: the graph neural network is a windowed graph neural network; and the respective subset of graph nodes is obtained using a sliding window over the plurality of pixels.

Aspect 17. The apparatus of any of Aspects 1 to 16, wherein each feature of the plurality of features includes a coarse depth estimation for a pixel of the plurality of pixels and one or more segmentation class probabilities associated with the pixel.

Aspect 18. The apparatus of any of Aspects 1 to 17, wherein each feature of the plurality of features further includes pixel coordinate information of a position of the particular pixel in the image.

Aspect 19. The apparatus of any of Aspects 1 to 18, wherein each feature of the plurality of features further includes positional information indicative of a position of the particular pixel in the image.

Aspect 20. The apparatus of Aspect 19, wherein the positional information is a positional encoding indicative of pixel coordinate information of the position of the particular pixel in the image.

Aspect 21. The apparatus of any of Aspects 19 to 20, wherein: each pixel of the plurality of pixels is associated with a respective patch of a plurality of patches, the respective patch including a subset of the plurality of pixels; the positional information is a positional encoding indicative of the respective patch associated with the particular pixel and a position of the particular pixel in the respective patch.

Aspect 22. The apparatus of Aspect 21, wherein: the respective patch includes pixels in a same column of the image; and the position of the particular pixel in the respective patch comprises a row index.

Aspect 23. The apparatus of any of Aspects 1 to 22, wherein each feature of the plurality of features further includes an uncertainty value associated with the respective depth information of the particular pixel.

Aspect 24. A method for generating depth information from one or more images, the method comprising: obtaining segmentation information associated with an image of a scene, the image including a plurality of pixels having a resolution; obtaining depth information associated with one or more objects in the scene; generating a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and processing the plurality of features to generate a dense depth output corresponding to the image.

Aspect 25. The method of Aspect 24, wherein: the plurality of features are processed using a graph neural network to generate the dense depth output corresponding to the image; the segmentation information includes a segmentation map of the image, the segmentation map having the resolution; and the depth information includes a coarse depth map comprising a plurality of locations having the resolution.

Aspect 26. The method of Aspect 25, further comprising: determining contextual information associated with at least one location of the plurality of locations, the contextual information indicative of an absolute pixel location of the at least one location or indicative of a relative pixel location of the at least one location.

Aspect 27. The method of Aspect 26, wherein the contextual information is further indicative of an object classification associated with a sparse depth value obtained for the at least one location.

Aspect 28. The method of any of Aspects 25 to 27, wherein obtaining the segmentation information comprises: obtaining the image of the scene; and generating, using a segmentation machine learning network, the segmentation map based on the image of the scene.

Aspect 29. The method of any of Aspects 25 to 28, wherein each location of the plurality of locations in the coarse depth map includes a value representing a respective measured depth or a respective predicted depth of a pixel having a corresponding location in the image.

Aspect 30. The method of Aspect 29, wherein: each feature of the plurality of features further includes a depth uncertainty value associated with the respective depth information of the particular pixel; the depth uncertainty value is zero based on the respective depth information comprising a measured depth from the coarse depth map; and the depth uncertainty value is a calculated uncertainty based on the respective depth information comprising a predicted depth from the coarse depth map.

Aspect 31. The method of Aspect 30, wherein determining the calculated uncertainty comprises: determining a variance of a plurality of predicted depth values from the coarse depth map.

Aspect 32. The method of any of Aspects 30 to 31, wherein determining the calculated uncertainty comprises: determining a variance of class predictions from the segmentation map of the image.

Aspect 33. The method of any of Aspects 25 to 32, wherein obtaining the depth information comprises: obtaining a sparse depth map associated with one or more objects in the scene, the sparse depth map comprising a plurality of locations having the resolution; and generating, using a coarse depth prediction machine learning network, the coarse depth map based on the sparse depth map and the image of the scene.

Aspect 34. The method of Aspect 33, wherein: each location of a first subset of locations of the plurality of locations in the sparse depth map includes a value representing a respective depth of a respective pixel having a corresponding location in the image; and each location of a second subset of locations of the plurality of locations in the sparse depth map includes a zero-value corresponding to a lack of depth information for a respective pixel having a corresponding location in the image.

Aspect 35. The method of any of Aspects 24 to 34, further comprising: generating a plurality of graph nodes using the plurality of features, wherein each graph node of the plurality of graph nodes includes a respective feature of the plurality of features corresponding to a particular pixel of the plurality of pixels.

Aspect 36. The method of Aspect 35, wherein generating the dense depth output comprises: determining a predicted depth value for each respective pixel of the plurality of pixels; and generating the dense depth output using the predicted depth value for each respective pixel of the plurality of pixels.

Aspect 37. The method of Aspect 36, wherein determining the predicted depth value for a pixel of the plurality of pixels comprises: obtaining a respective subset of graph nodes included in the plurality of graph nodes, the respective subset of graph nodes corresponding to the pixel; and processing, using an adjacency matrix and one or more graph convolution layers of a graph neural network, the respective subset of graph nodes to generate the predicted depth value for the pixel.

Aspect 38. The method of Aspect 37, wherein the respective subset of graph nodes includes: a graph node corresponding to the pixel; and one or more adjacent graph nodes, each adjacent graph node corresponding to a pixel of the plurality of pixels that is adjacent to the pixel.

Aspect 39. The method of any of Aspects 37 to 38, wherein: the graph neural network is a windowed graph neural network; and the respective subset of graph nodes is obtained using a sliding window over the plurality of pixels.

Aspect 40. The method of any of Aspects 24 to 39, wherein each feature of the plurality of features includes a coarse depth estimation for a pixel of the plurality of pixels and one or more segmentation class probabilities associated with the pixel.

Aspect 41. The method of any of Aspects 24 to 40, wherein each feature of the plurality of features further includes pixel coordinate information of a position of the particular pixel in the image.

Aspect 42. The method of any of Aspects 24 to 41, wherein each feature of the plurality of features further includes positional information indicative of a position of the particular pixel in the image.

Aspect 43. The method of Aspect 42, wherein the positional information is a positional encoding indicative of pixel coordinate information of the position of the particular pixel in the image.

Aspect 44. The method of any of Aspects 42 to 43, wherein: each pixel of the plurality of pixels is associated with a respective patch of a plurality of patches, the respective patch including a subset of the plurality of pixels; the positional information is a positional encoding indicative of the respective patch associated with the particular pixel and a position of the particular pixel in the respective patch.

Aspect 45. The method of Aspect 44, wherein: the respective patch includes pixels in a same column of the image; and the position of the particular pixel in the respective patch comprises a row index.

Aspect 46. The method of any of Aspects 24 to 45, wherein each feature of the plurality of features further includes an uncertainty value associated with the respective depth information of the particular pixel.

Aspect 47. Anon-transitory computer-readable medium including instructions that, when executed by at least one processor, cause the at least one processor to perform operations according to any of Aspects 1 to 23.

Aspect 48. Anon-transitory computer-readable medium including instructions that, when executed by at least one processor, cause the at least one processor to perform operations according to any of Aspects 24 to 46.

Aspect 49. An apparatus for processing image data, the apparatus comprising one or more means for performing operations according to any of Aspects 1 to 23.

Aspect 50. An apparatus for processing image data, the apparatus comprising one or more means for performing operations according to any of Aspects 24 to 46.

What is claimed is:

1. An apparatus for generating depth information from one or more images, the apparatus comprising:
at least one memory; and
at least one processor coupled to the at least one memory, the at least one processor being configured to:
obtain segmentation information associated with an image of a scene, the image including a plurality of pixels having a resolution;
obtain depth information associated with one or more objects in the scene;
generate a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and
process the plurality of features to generate a dense depth output corresponding to the image.

2. The apparatus of claim 1, wherein:
the at least one processor is configured to process, using a graph neural network, the plurality of features to generate the dense depth output corresponding to the image;
the segmentation information includes a segmentation map of the image, the segmentation map having the resolution; and
the depth information includes a coarse depth map comprising a plurality of locations having the resolution.

3. The apparatus of claim 2, wherein the at least one processor is further configured to:
determine contextual information associated with at least one location of the plurality of locations, the contextual information indicative of an absolute pixel location of the at least one location or indicative of a relative pixel location of the at least one location.

4. The apparatus of claim 3, wherein the contextual information is further indicative of an object classification associated with a sparse depth value obtained for the at least one location.

5. The apparatus of claim 2, wherein, to obtain the segmentation information, the at least one processor is configured to:
obtain the image of the scene; and
generate, using a segmentation machine learning network, the segmentation map based on the image of the scene.

6. The apparatus of claim 2, wherein each location of the plurality of locations in the coarse depth map includes a value representing a respective measured depth or a respective predicted depth of a pixel having a corresponding location in the image.

7. The apparatus of claim 6, wherein each feature of the plurality of features further includes a depth uncertainty value associated with the respective depth information of the particular pixel, and wherein:
the depth uncertainty value is zero based on the respective depth information comprising a measured depth from the coarse depth map; and
the depth uncertainty value is a calculated uncertainty based on the respective depth information comprising a predicted depth from the coarse depth map.

8. The apparatus of claim 7, wherein, to determine the calculated uncertainty, the at least one processor is configured to:
determine a variance of a plurality of predicted depth values from the coarse depth map.

9. The apparatus of claim 7, wherein, to determine the calculated uncertainty, the at least one processor is configured to:
determine a variance of class predictions from the segmentation map of the image.

10. The apparatus of claim 2, wherein, to obtain the depth information, the at least one processor is configured to:
obtain a sparse depth map associated with one or more objects in the scene, the sparse depth map comprising a plurality of locations having the resolution; and
generate, using a coarse depth prediction machine learning network, the coarse depth map based on the sparse depth map and the image of the scene.

11. The apparatus of claim 10, wherein:
each location of a first subset of locations of the plurality of locations in the sparse depth map includes a value representing a respective depth of a respective pixel having a corresponding location in the image; and
each location of a second subset of locations of the plurality of locations in the sparse depth map includes a zero-value corresponding to a lack of depth information for a respective pixel having a corresponding location in the image.

12. The apparatus of claim 1, wherein the at least one processor is configured to generate a plurality of graph nodes using the plurality of features, and wherein each graph node of the plurality of graph nodes includes a respective feature of the plurality of features corresponding to a particular pixel of the plurality of pixels.

13. The apparatus of claim 12, wherein, to generate the dense depth output, the at least one processor is configured to:
determine a predicted depth value for each respective pixel of the plurality of pixels; and
generate the dense depth output using the predicted depth value for each respective pixel of the plurality of pixels.

14. The apparatus of claim 13, wherein, to determine the predicted depth value for a pixel of the plurality of pixels, the at least one processor is configured to:
obtain a respective subset of graph nodes included in the plurality of graph nodes, the respective subset of graph nodes corresponding to the pixel; and
process, using an adjacency matrix and one or more graph convolution layers of a graph neural network, the respective subset of graph nodes to generate the predicted depth value for the pixel.

15. The apparatus of claim 14, wherein the respective subset of graph nodes includes:
a graph node corresponding to the pixel; and
one or more adjacent graph nodes, each adjacent graph node corresponding to a pixel of the plurality of pixels that is adjacent to the pixel.

16. The apparatus of claim 14, wherein:
the graph neural network is a windowed graph neural network; and
the respective subset of graph nodes is obtained using a sliding window over the plurality of pixels.

17. The apparatus of claim 1, wherein each feature of the plurality of features includes a coarse depth estimation for a pixel of the plurality of pixels and one or more segmentation class probabilities associated with the pixel.

18. The apparatus of claim 1, wherein each feature of the plurality of features further includes pixel coordinate information of a position of the particular pixel in the image.

19. The apparatus of claim 1, wherein each feature of the plurality of features further includes positional information indicative of a position of the particular pixel in the image.

20. The apparatus of claim 19, wherein the positional information is a positional encoding indicative of pixel coordinate information of the position of the particular pixel in the image.

21. The apparatus of claim 19, wherein:
each pixel of the plurality of pixels is associated with a respective patch of a plurality of patches, the respective patch including a subset of the plurality of pixels;
the positional information is a positional encoding indicative of the respective patch associated with the particular pixel and a position of the particular pixel in the respective patch.

22. The apparatus of claim 21, wherein:
the respective patch includes pixels in a same column of the image; and
the position of the particular pixel in the respective patch comprises a row index.

23. The apparatus of claim 1, wherein each feature of the plurality of features further includes an uncertainty value associated with the respective depth information of the particular pixel.

24. A method for generating depth information from one or more images, the method comprising:
obtaining segmentation information associated with an image of a scene, the image including a plurality of pixels having a resolution;
obtaining depth information associated with one or more objects in the scene;
generating a plurality of features corresponding to the plurality of pixels, wherein each feature of the plurality of features corresponds to a particular pixel of the plurality of pixels, and wherein each feature includes respective segmentation information of the particular pixel and respective depth information of the particular pixel; and
processing the plurality of features to generate a dense depth output corresponding to the image.

25. The method of claim 24, wherein:
the plurality of features are processed using a graph neural network to generate the dense depth output corresponding to the image;
the segmentation information includes a segmentation map of the image, the segmentation map having the resolution; and
the depth information includes a coarse depth map comprising a plurality of locations having the resolution.

26. The method of claim 25, wherein obtaining the segmentation information comprises:
obtaining the image of the scene; and
generating, using a segmentation machine learning network, the segmentation map based on the image of the scene.

27. The method of claim 25, wherein each location of the plurality of locations in the coarse depth map includes a value representing a respective measured depth or a respective predicted depth of a pixel having a corresponding location in the image.

28. The method of claim 27, wherein:
each feature of the plurality of features further includes a depth uncertainty value associated with the respective depth information of the particular pixel;
the depth uncertainty value is zero based on the respective depth information comprising a measured depth from the coarse depth map; and
the depth uncertainty value is a calculated uncertainty based on the respective depth information comprising a predicted depth from the coarse depth map.

29. The method of claim 28, wherein determining the calculated uncertainty comprises:
determining a variance of a plurality of predicted depth values from the coarse depth map.

30. The method of claim 27, wherein determining the calculated uncertainty comprises:
determining a variance of class predictions from the segmentation map of the image.
